(19) United States
(12) Patent Application Publication
(10) Pub. No.: US 2009/0085307 A1
(43) Pub. Date: Apr. 2, 2009

(54) MACHINE TOOL BIT HOLDER WITH ADJUSTABLE JAWS

(76) Inventor: David Tom, San Francisco, CA (US)

Correspondence Address: MARION E. "GENE" CAVANAUGH, 306 CENTRAL AVENUE, MOUNTAIN VIEW, CA, 94043-4806, US

(21) Appl. No.: 11/864,181

(22) Filed: Sep. 28, 2007

(51) Int. Cl. B23B 5/22

(52) U.S. Cl. 279/61; 279/102

(57) ABSTRACT

A machine tool bit holder providing a stable connection between a machine and a tool bit being used to perform machining operations on a work piece. The holder for the tool bit is of simple construction and has a large contact area relative to a tool bit size and a holder size between the holder and the tool bit, and the holder is configured so that the tool bit can be easily mounted into and dismounted from the holder. The holder allows different shapes or configurations of tool bits, such as an angle between the holder and the tool bit, and tool bits that are substantially rectangular as well as substantially round in cross-section.

### CROSS-REFERENCE TO RELATED PUBLICATIONS

| Patent Number | Title | Issue date |
|---|---|---|
| EP1488876 | Shrink fit holder and methods of | Dec. 22, 2004 |
| | drilling and reaming | |
| 7077608 | System for mounting a machine tool | Jul. 18, 2006 |
| | in a holder | |

### BACKGROUND OF THE INVENTION

Machine tools, such as lathes, screw cutters, boring devices, and the like, as they are commonly known in the art, provide for a rigidly held work piece which is rotated or otherwise manipulated around or along some axis, while a fixed tool such as a holder with a tool bit therein is introduced to the work piece for removing unwanted material from said work piece. It is imperative that both the tool and the work piece be rigidly held with respect to each other, except for the motion introduced to allow the tool to operate on the work piece.

Alternatively, the work piece is fixed as the tool is rotated or manipulated for the above purpose.

A tool bit, which is the part of the tool effecting said removal of material, is both expensive and difficult to form properly. The tool bit is normally made of a special hardened material to allow removal of material without excessive wear or damage to the tool bit or damage to the work piece due to excessive vibration of the tool bit.

Consequently, the tool bit is made as small as is practical to minimize both material and preparation expense. However, the tool bit must not be unduly fragile, due to the possibility of breakage with high stresses, and the need to suppress vibration in the bit to avoid damage to the work piece. As disclosed above, the tool bit is normally held in a tool bit holder, which helps to minimize the material required for the bit, and allows for easier mounting and use. The size of the tool bit is determined in large part by the ability of the holder to contain the bit properly.

One type of tool bit holder useful to those in the art is the so-called chuck. The chuck is designed to hold a bit axially within the chuck, normally by means of “fingers”, or multiple extensions from within the chuck along the long axis of the bit, with the fingers being urged against the bit to secure the bit firmly. The chuck does not readily allow for any other angle than axial with the chuck for the deployment of the bit.

A simple holder, as opposed to a chuck, rigidly holds a work piece, such as other than axially with the holder, and when the work piece is rotated or otherwise manipulated around or along some axis, the tool bit in the holder is introduced to the work piece for removing unwanted material from said work piece.

Alternatively, the work piece is fixed and the holder with a tool bit is rotated or otherwise manipulated for the above purpose.

A primary purpose of the holder is to provide both a secure connection to the machine tool and a secure connection to the tool bit. Normally, the bit is inserted into the holder, such as in a groove or other type of receptacle for the bit, and is secured there by some stable means. The securing means is normally a set of set screws which thread through the holder and force the bit against an edge of the holder, the edge being formed for that purpose. Since the areas of the set screw ends are comparatively small, holding the bit securely requires substantial force on the screws, both for clamping the bit in place and for minimizing vibration of the bit. These requirements often determine a minimum size of bit that can be used without an unacceptable risk of damage to the bit or vibration of the bit. A larger bit is more expensive and may require a larger holder, which is disadvantageous, both for the expense involved and for the limitations in operating in confined spaces which are introduced thereby.

An alternative holder of the current art is the “shrink fit” holder. With the shrink fit holder, the recess in the holder is too small to allow the bit to be inserted, until the holder is heated with respect to the bit or the bit is cooled with respect to the holder, or both. The differences in the thermal expansion of the holder and the tool bit, when the holder is heated relative to the bit, allows the bit to be inserted. When the holder and bit are allowed to stabilize at the same temperature the bit is securely held in the holder.

With the shrink fit holder, a smaller bit may be used, with corresponding savings in both material cost and bit preparation expense. The smaller bit is made practical because the securing force is spread over a larger area and less force is applied to any one point on the bit. Also, the larger area of contact, relative to the size of the holder and the size of the bit, minimizes vibration.

A problem with the shrink fit holder is that it is very difficult to remove the bit from the holder when it is desired to use another bit, such as with bit wear or breakage. As a result, the shrink fit holder normally requires special equipment, or a holder must be dedicated to a specific bit. Another problem is that the process for inserting the tool bit into the holder is relatively time-consuming and expensive, since heating and cooling operations are required.

### BRIEF SUMMARY OF THE INVENTION

In this invention, a holder having jaws on deformable arms is provided. The jaws of the holder are of a substantial enough nature to hold the tool bit securely with a relatively large area of contact, but the holder is small compared to prior art holders for the area of contact achieved. The jaws are arranged on the arms of the holder in an opposing manner, with the arms being relatively wide in a direction parallel to both of the arms. In this way, when a bit is held, the two holder arms form a triangular structure with good stability, even with relatively flexible arms. The width of the arms provide lateral support, whereby each arm stabilizes the other and the bit is held securely thereby.

The jaws of the holder of this invention are at an extreme end of said holder, and in the initial state are so disposed as to hold the tool bit with a light touch, or “slip fit”. The two arms, or arm-like extensions, hold the jaws essentially on the end of cantilever levers, and the jaws can be slightly flexed by the user when it is desired to clamp the tool bit. The extensions so formed may be further thinned at the far end of the arms from the jaws for allowing preferential flexing at that point. The thinning at the far end of the arms is normally by removal of some of the holder material, allowing the thinning to be accomplished such as by drilling a hole through the holder parallel to said width of said arms at said far end of said arms from said jaws.

As disclosed above, the jaws are flexed together when it is desired to clamp a tool bit, such as by applying pressure on the sides of the jaws or on the sides of the arms. In a preferred embodiment, this pressure is provided by tightening a set screw mounted on said arms between said ends of said arms, the set screw forming a slip fit with a first arm, and threaded into a second arm. A head of the set screw applies the desired pressure on an outside surface of the first arm when the screw is tightened into the second arm.

While the tool bit is normally rectangular in cross-section, it will be clear that tool bits having other cross-sections can also be accommodated, such as by introducing a contour into the jaws where they meet the tool bit in order to hold, for example, a round bit.

The preferential flexing so allowed provides advantages similar to a shrink fit holder by providing a relatively large area and secure contact with a tool bit, as compared to the bit size or holder size, but further allows the tool bit to be easily inserted into or released from the holder by simply relieving the flexure, such as by loosening a set screw.

### BRIEF DESCRIPTION OF THE SEVERAL VIEWS OF THE INVENTION

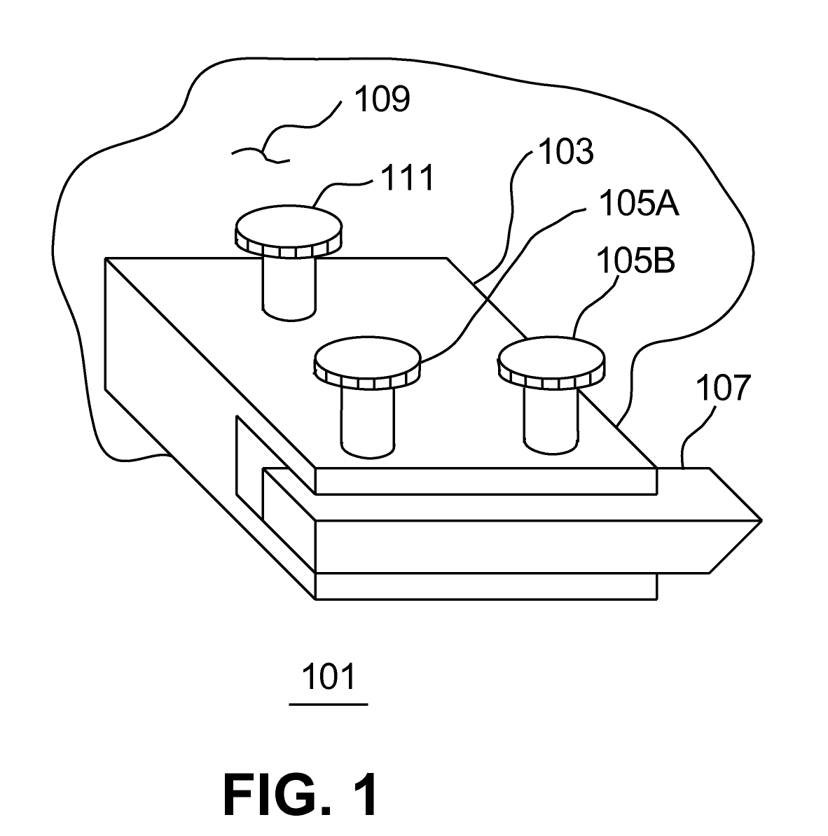

An embodiment of the prior art shown in FIG. 1 illustrates a tool bit holder of the prior art utilizing set screws in a machined groove for holding a tool bit.

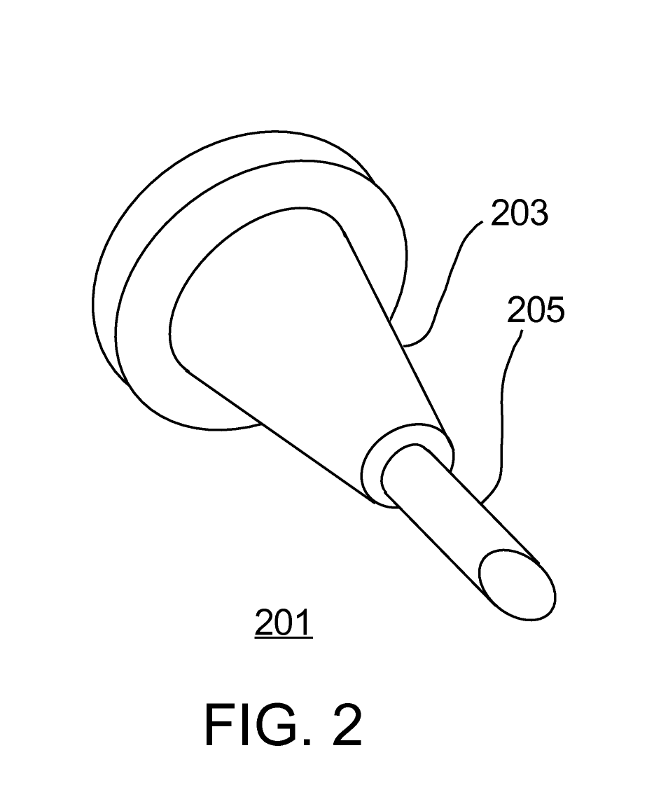

Another embodiment of the prior art shown in FIG. 2 illustrates a shrink fit holder.

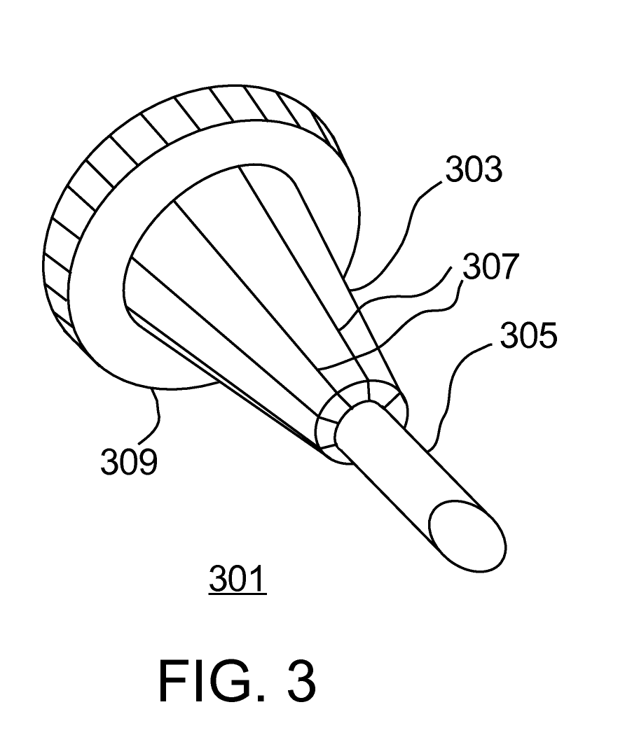

Yet another embodiment of the prior art shown in FIG. 3 illustrates a tool bit in a chuck.

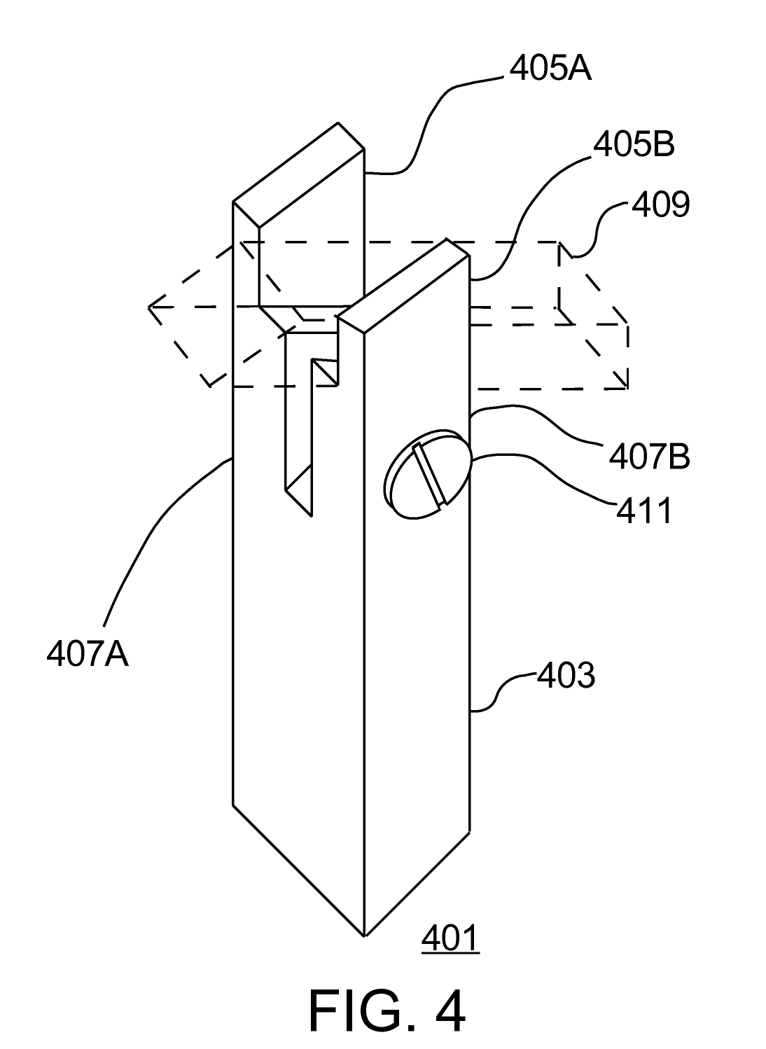

An embodiment of the invention shown in FIG. 4 illustrates mounting a tool bit at an arbitrary angle with respect to a holder.

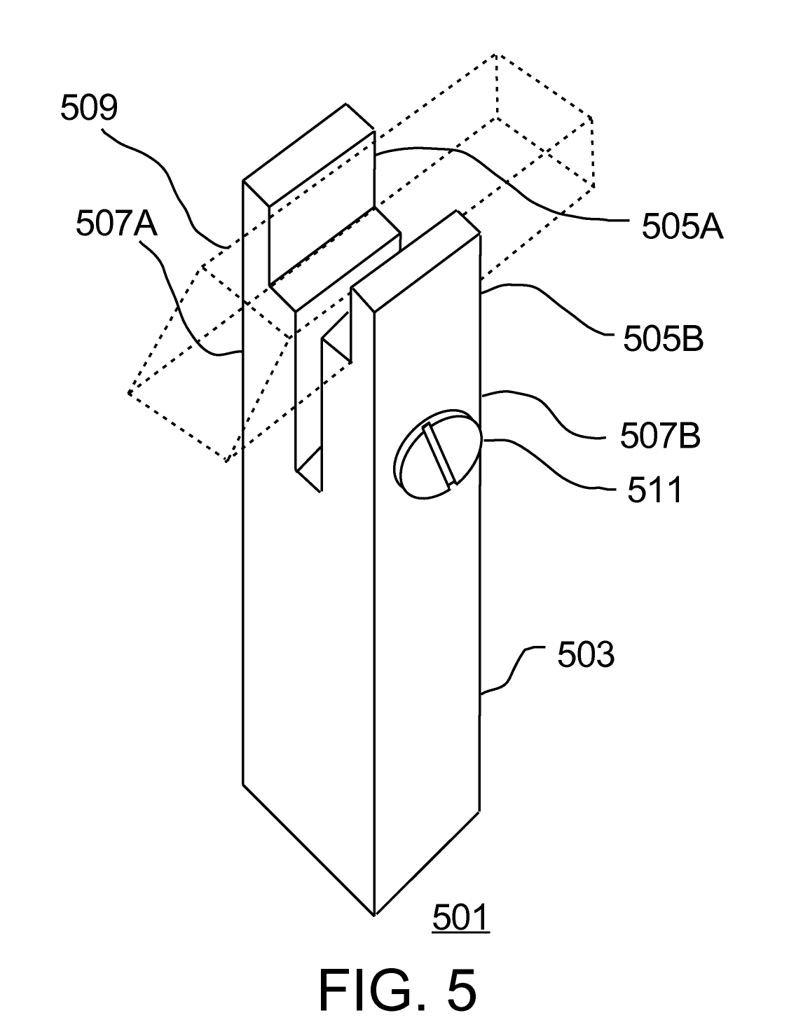

Another embodiment of the invention shown in FIG. 5 illustrates mounting a tool bit at an angle of substantially 90 degrees, or normal to, a holder.

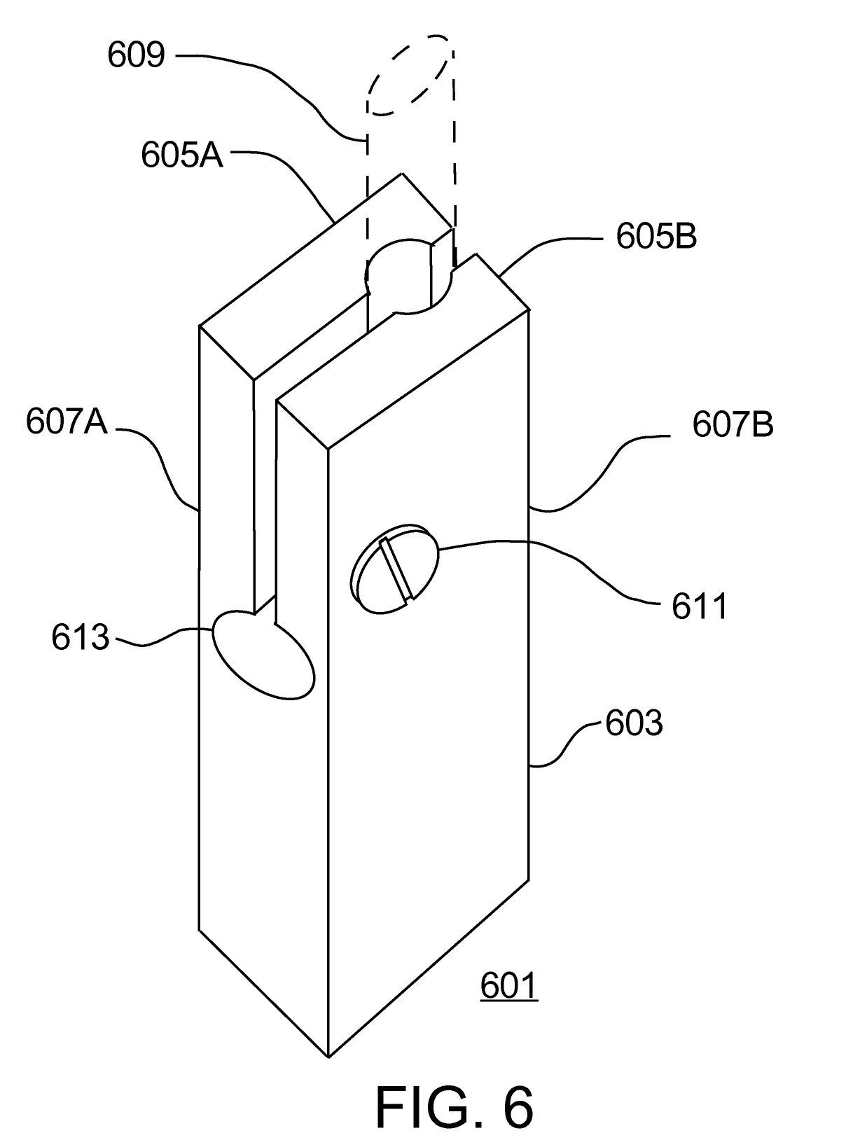

Yet another embodiment of the invention shown in FIG. 6 illustrates configuring a tool bit along a long axis of a holder, by offsetting a set screw.

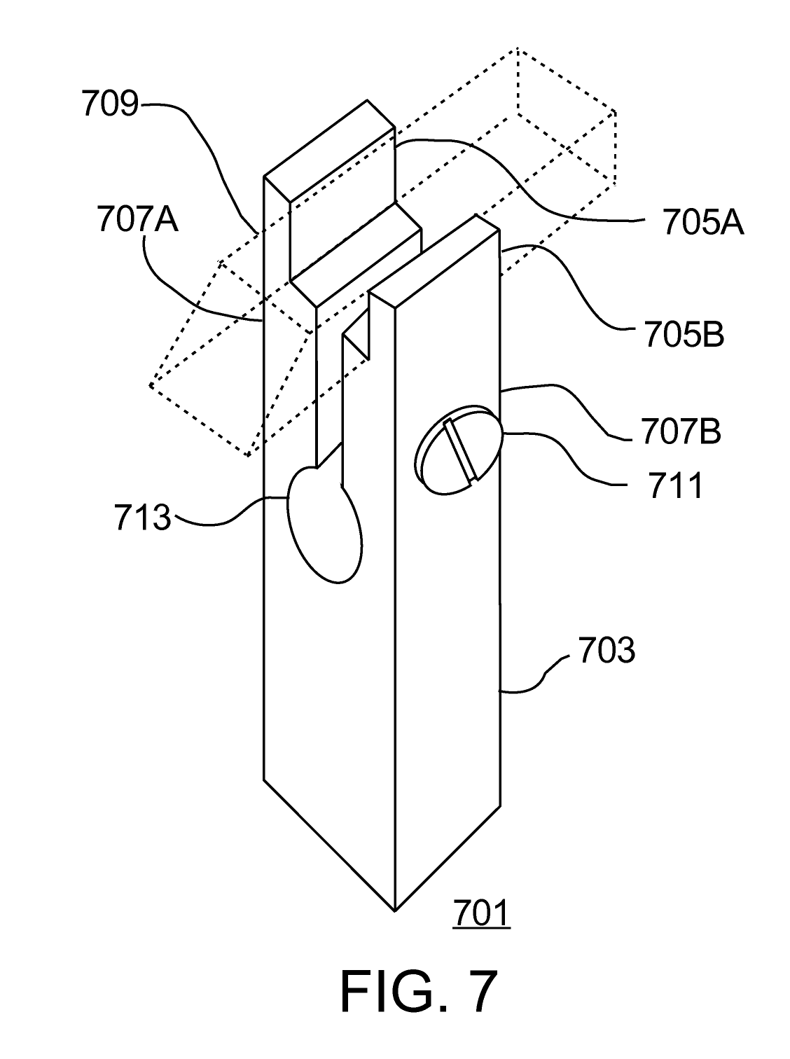

A preferred embodiment of the invention shown in FIG. 7 illustrates mounting a tool bit at an arbitrary angle to a long axis of a holder, such as normal to the holder, and the removal of material, such as by drilling through the holder parallel to arms of the holder, to increase flexure at a preferential point on the arms.

### DETAILED DESCRIPTION OF THE INVENTION

In an embodiment 101 of the prior art shown in FIG. 1, a tool bit holder 103 having set screws 105A and 105B is configured to hold a tool bit 107. Holder 103 is attached to a machine 109 (partially shown) with mounting bolt 111. Machine 109 holds and rotates or otherwise manipulates a work piece (not shown) for tool bit 107 to operate on, or optionally rotates or otherwise manipulates tool bit 107 to operate on a work piece (not shown). The need for multiple set screws 105A and 105B and the small area of the contact between the screws and the tool bit results in a more complex and restrictive holder and larger tool bit than is often desired by those in the art.

In another embodiment 201 of the prior art, shown in FIG. 2, a partial view of a tool bit holder 203 is shrink fitted around a tool bit 205, and tool bit 205 is thereby tightly contained within holder 203. Holder 203 is also attached to a machine (not shown) to allow tool bit 205 to operate on a work piece (not shown). The necessity for heating and cooling holder 203 to insert and remove tool bit 205 places restrictions on the shapes and sizes of tool bit 205 and holder 203, resulting in a more complex and restrictive holder 203 than is often desired by those in the art.

In yet another embodiment 301 of the prior art shown in FIG. 3, a partial view of a tool bit holder 303 comprising a chuck is fitted around a tool bit 305, and tool bit 305 is thereby tightly contained within holder 303. Holder 303 is also attached to a machine (not shown) to allow tool bit 305 to operate on a work piece (not shown). Because the chuck fingers 307 are forced inward onto the tool bit body, or shank, such as by tightening a knurl nut 309, the tool bit 305 is normally constrained parallel to a long axis of the holder 303, which results in a holder 303 that is more complex and restrictive than is often desired by those in the art.

In an embodiment 401 of the invention shown in FIG. 4, a tool bit holder 403 has two jaws 405A and 405B cut into arms 407A and 407B at an arbitrary angle at first ends of arms 407A and 407B of the holder 403. Holder 403, having minimal adjustment requirements for holding a tool bit 409 (shown with dashed lines for clarity), optimally provides a relatively large area of contact to tool bit 409 compared to a size of bit 409 and holder 403, and is thereby made compact for use in a wide variety of machine tools. It will be clear to those in the art that otherwise shaping the arms 407A and 407B will allow greater or lesser flexure of the arms 407A and 407B for greater or lesser pressure on the tool bit 409 with a given operation of a set screw 411. It will be also be apparent to those in the art that a variety of shapes and configurations of tool bit 409 may be accommodated, such as substantially rectangular or substantially round. Jaws 405A and 405B are readily shaped to hold tool bit 409 at some arbitrary angle when jaws 405A and 405B are flexed inwardly, such as by tightening set screw 411. Other methods of providing flexure to the arms 407A and 407B for holding tool bit 409 firmly while providing an arbitrary angle for tool bit 409 will be clear to those in the art. Replacement of bit 409 is readily accomplished by loosening set screw 411, allowing holder 403 to be easily reused. The holder 403, though simpler than most prior art holders, is easily configured for use in a wide variety of machines (not shown) and for machining a variety of work pieces (not shown).

In another embodiment 501 of the invention shown in FIG. 5, a tool bit holder 503 has jaws 505A and 505B. Jaws 505A and 505B are on first ends of arms 507A and 507B of the holder 503. Holder 503, having minimal adjustment requirements for a tool bit 509 (shown with dashed lines for clarity), optimally provides a relatively large area of contact to tool bit 509 and is thereby made compact for use in a wide variety of machine tools (not shown). It will be apparent to those in the art that arms 507A and 507B may be shaped for greater flexibility. It will be also be apparent to those in the art that a variety of shapes and configurations for tool bit 509 are accommodated, such as substantially rectangular or substantially round. Jaws 505A and 505B firmly hold tool bit 509 when jaws 505A and 505B are flexed inwardly such as by tightening a set screw 511 Replacement of bit 509 is easily accomplished by loosening set screw 511, allowing holder 503 to be easily reused. The holder 503, being simpler than prior art holders, is easily configured for use in a wide variety of machines (not shown).

In yet another embodiment 601 of the invention shown in FIG. 6, a tool bit holder 603 has jaws 605A and 605B configured to accept a tool bit 609 with the long axis of the tool bit 609 parallel to the long axis of the holder 603. Jaws 605A and 605B are on ends of arms 607A and 607B of the holder 603. Holder 603 having minimal adjustment requirements, optimally provides a relatively large area of contact to a tool bit 609 (shown with dashed lines for clarity) by a flexure means such as a set screw 611, and is thereby made compact for use in a wide variety of machine tools (not shown). It will be apparent to those in the art that a variety of shapes and configurations of tool bit 609 are accommodated, such as substantially rectangular, or substantially round as shown in embodiment 601. The jaws 605A and 605B securely hold tool bit 609 when jaws 605A and 605B are flexed inwardly such as by tightening set screw 611. In this embodiment, to accommodate set screw 611 without interference with tool bit 609, holder 603 is made wider to provide wider arms 607A and 607B, and flexibility of arms 607A and 607B is maintained in the correspondingly wider arms 607A and 607B by preferentially further thinning arms 607A and 607B, such as by removing material from a second end 613 of arms 607A and 607B. Other methods of providing additional flexure to the arms will be clear to those in the art. Replacement of bit 609 is accomplished by loosening set screw 611, allowing holder 603 to be easily reused. Holder 603, being simpler than prior art holders, is easily configured for use in a wide variety of machines (not shown) and for machining diverse work pieces (not shown).

In a preferred embodiment 701 of the invention shown in FIG. 7, a tool bit holder 703 having two jaws 705A and 705B on first ends of arms 707A and 707B is shown. Holder 703, having minimal adjustment requirements, mounts tool bit 709 at an arbitrary angle with respect to the long axis of the holder, and provides a relatively large, secure contact to a tool bit 709 (shown with dashed lines for clarity) by a flexure means such as set screw 711. Holder 703 is thereby made optimally compact for use in a wide variety of machine tools (not shown). It will be apparent to those in the art that a variety of shapes and configurations of tool bit 709 are accommodated, such as substantially rectangular or substantially round. Jaws 705A and 705B hold tool bit 709 securely when jaws 705A and 705B are flexed inwardly such as by tightening set screw 711. Additional flexure of the arms 707A and 707B is provided, such as by removing material from holder 703 at second end 713 of arms 707A and 707B. Replacement of bit 709 is readily accomplished by loosening set screw 711, allowing holder 703 to be easily reused. Holder 703, being simpler than prior art holders, is readily configured for use in a wide variety of machines (not shown) and for machining diverse work pieces (not shown).

I claim:

1. a machine tool bit holder for a machine providing a stable connection between said holder and a tool bit used to perform machining operations on a work piece with said machine, wherein the invention comprises:
providing said holder having arms with jaws for holding said tool bit with a large contact area, relative to a size of said holder and a size of said tool bit, so said tool bit is relatively small and firmly held in a relatively small holder.

2. the holder of claim 1 further comprising:
providing for different configurations of tool bits, including tool bits that are substantially rectangular or substantially round in cross-section.

3. the holder of claim 1 further comprising:
modifying a shape of said arms on said holder, to allow greater or lesser pressure to be applied to said tool bit by a flexure of said arms.

4. the holder of claim 1 further comprising:
flexing said arms for securing said tool bit with a means for forcing said arms closer together.

5. the holder of claim 4 further comprising:
said means for forcing said arms closer together is a set screw.

6. the holder of claim 1 further comprising:
providing a holder for said tool bit which is readily configurable to accommodate various angles for said tool bit relative to said holder so that said holder is optimized for a wide variety of machines.

7. a machine tool bit holder for a machine tool bit providing a stable connection between a machine and a tool bit used to perform machining operations on a work piece in said machine, wherein the invention comprises:
providing arms with jaws having a large contact area, relative to a size of said holder and a size of said tool bit, between said holder and said tool bit, said tool bit being easily mounted into and dismounted from said holder.

8. the holder of claim 7 further comprising:
providing for different configurations of tool bits, including tool bits that are substantially rectangular or substantially round in cross-section.

9. the holder of claim 7 further comprising:
modifying a shape of said arms on said holder, to allow greater or lesser pressure to be applied to said tool bit with said jaws by a flexure of said arms.

10. the holder of claim 7 further comprising:
flexing said arms for securing said tool bit with a means for forcing said arms closer together.

11. the holder of claim 10 further comprising:
said means for forcing said arms closer together is a set screw.

12. the holder of claim 7 further comprising:
providing a holder for said tool bit which is readily configurable to accommodate various angles for said tool bit relative to said holder so that said holder is optimized for a wide variety of machines.

13. a machine tool bit holder for a machine tool bit for providing a stable connection between a machine and a tool bit used to perform machining operations on a work piece in said machine, wherein the invention comprises:
providing said holder for said tool bit with a simple structure having arms with jaws thereon whereby said holder is made cost effective and is readily fitted into said machine.

14. the holder of claim 13 further comprising:
providing for different configurations of tool bits, including tool bits that are substantially rectangular or substantially round in cross-section.

15. the holder of claim 13 further comprising:
modifying a shape of said arms on said holder, to allow greater or lesser pressure to be applied to said tool bit by a flexure of said arms.

16. the holder of claim 13 further comprising:
flexing said arms for securing said tool bit with a means for forcing said arms closer together.

17. the holder of claim 3 further comprising:
said means for forcing said arms closer together is a set screw.

18. the holder of claim 13 further comprising:
providing a holder for said tool bit which is relatively small compared to a size of a contact between said holder and said tool bit, but is readily configurable to accommodate various angles for said tool bit relative to said holder so that said holder is optimized for a wide variety of machines.

19. the holder of claim 1 further comprising:
providing a holder with arms in which one or both arms are separate pieces from the body of the holder.

20. the holder of claim 19 further comprising:
the arms being of a dissimilar material from the body of the holder.
